(19) United States
(12) Patent Application Publication
(10) Pub. No.: US 2008/0119080 A1
(43) Pub. Date: May 22, 2008

(54) Zoom lens camera module socket

(75) Inventor: Jen-Lee Wu, Taipei (TW)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/985,913

(22) Filed: Nov. 19, 2007

(30) Foreign Application Priority Data
Nov. 17, 2006 (TW) 95220339

(51) Int. Cl. H01R 13/62

(52) U.S. Cl. 439/331

(57) ABSTRACT

An electrical connector includes a lens module, an insulating casing and a plurality of terminals. An outer edge of the lens module is wrapped by coils. The insulating casing has an accommodating space for accommodating the lens module. The bottom of the insulating casing is formed with a plurality of terminal troughs. The plurality of terminals is accommodated in the terminal troughs respectively. Each terminal has two ends. One end extends into the accommodating space to be electrically connected with the lens module, while the other end extends beyond the insulating casing. An engaging means is provided between the inner edge of the insulating casing and the outer edge of the lens module. Via the engaging means, the lens module can be engaged in the accommodating space of the insulating casing firmly.

### BACKGROUND OF THE INVENTION

The present invention is related generally to a camera module and more particularly to a camera module for use with zoon lens cameras.

Modern cell phones are usually equipped with digital cameras that are encased within modules. In order to assemble the module, the circuit board within the cell phone is provided with an electrical connector that mates with the camera.

FIGS. 1 to 3, respectively show an assembled perspective view, a top view and a cross-sectional view of a conventional electrical connector for a camera module. In order to assemble the camera module 2a within an electrical connector 1a, the connector 1a includes an insulating housing 10a provided with a plurality of terminal slots 100a, a plurality of conductive terminals 11a accommodated in the terminal slots 100a, and a metallic casing 12a fixed to the outside of the housing 10a. The sides 120a of the metallic casing 12a are provided with a plurality of holding arms 121a. Each holding arm 121a is bent from an edge of the side 120a and extends toward the insulating casing 10a. Further, a free end of each holding arm 121a abuts against an outer edge of the camera module 2a assembled in the insulating casing 10a, thereby holding the camera module 2a. In prior art, similar technical measures have been disclosed in Taiwan Patent Application No. 095203378 and No. 093129776.

The above-mentioned camera module is usually a fixed-focus lens camera module. However, in order to meet the increasing demands of the customers for the additional functions within a cell phone, variable-focus lens camera modules are used instead. Coils are wrapped around the outer edge of the variable-focus lens module. When the electricity is supplied, the lens can be extended or retreated via the cooperation of the coils and magnets. In order to prevent foreign matters from touching the coils to cause a short circuit, a layer of insulating tape is provided that covers the outer surface of the coils.

However, when the variable-focus lens module is assembled in the electrical connector, the holding arms of the metallic casing of the electrical connector may scrape off the insulating tape on the module exterior and touches the coils, causing a short circuit.

Therefore, according to the above, the conventional electrical connector still has inconvenience and drawbacks in practice and thus needs to be improved.

### SUMMARY OF THE INVENTION

The object of the present invention is to provide a camera module socket connector, in which engaging pieces provided on an inner edge of the socket are used to engage a zoon lens camera module, thereby changing the way of holding the camera module by the holding arms on the side of the metallic casing. Thus, during an assembling process, the problem that the holding arms may scrape off the insulating tape outside the zoom lens module to cause a short circuit is prevented.

For achieving the object described above, the present invention provides an electrical connector, which includes: a zoom lens camera module, an outer edge thereof being wrapped by coils; a socket having an accommodating space for accommodating the lens module, the bottom of the socket being formed with a plurality of terminal troughs ro slots; and a plurality of terminals accommodated in the slots, each terminal having two ends, one end extending into the accommodating space for connection to the camera module, and the other end extending beyond the socket.

An engaging means is provided between the inner edge of the socket and the outer edge of the camera module. The camera module is held in the accommodating space of the socket firmly by this means. In a preferred embodiment of the present invention, the engaging means includes a plurality of engaging pieces and a stepped portion corresponding to the engaging pieces. The engaging pieces are integrally formed on the inner edge of the socket. The stepped portion is provided on the outer edge of the camera module.

In a preferred embodiment, each engaging piece is a protruding block. The outer surface of the protruding block is formed with an inclined guiding surface for allowing the camera module to slide thereon easily. The stepped portion is a trough.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is a perspective view showing a conventional electrical connector equipped with a lens module;

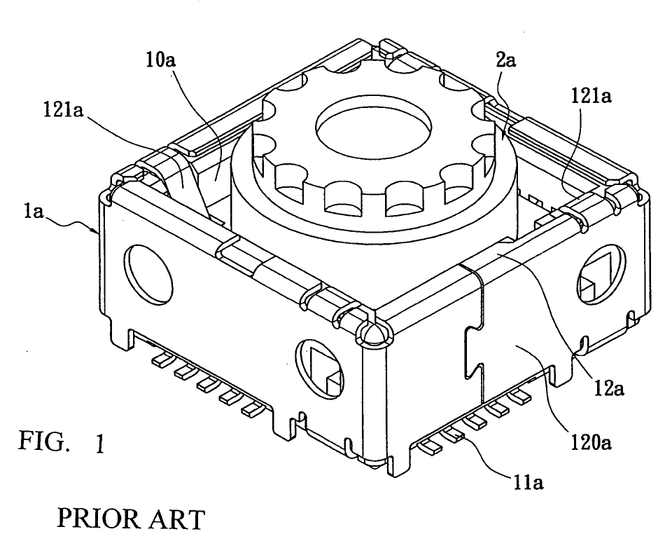

FIG. 2 is a top view of the connector of FIG. 1;

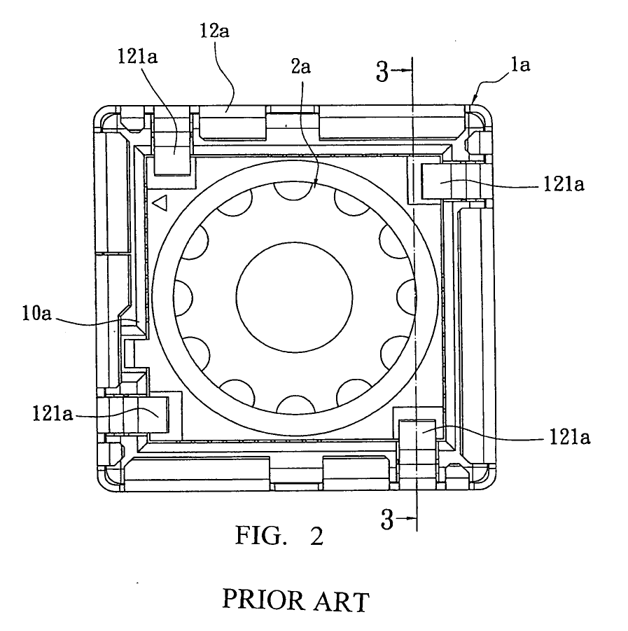

FIG. 3 is a cross-sectional view of FIG. 2 taken along line 3-3 thereof;

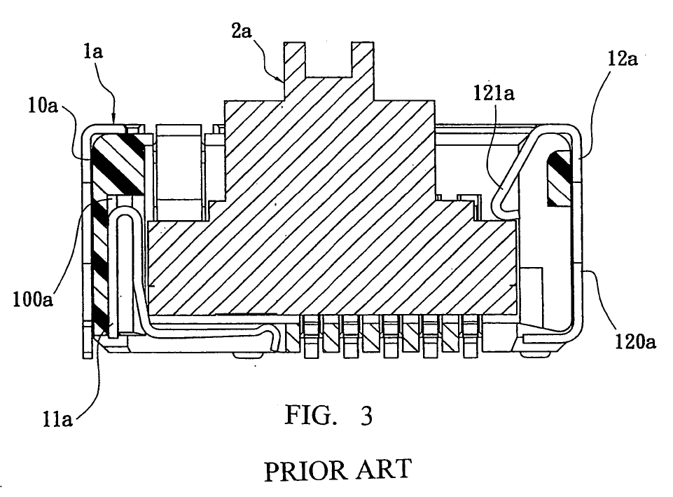

FIG. 4 is an exploded perspective view showing a camera module connector constructed in accordance with the principles of the present invention;

FIG. 5 is the same view as FIG. 4, but showing the connector thereof from a lower viewing angle;

FIG. 6 is an assembled perspective view of the connector of FIG. 4;

FIG. 7 is a side view of the connector of FIG. 6; and

FIG. 8 is a cross-sectional view of FIG. 7 taken along line 8-8 thereof.

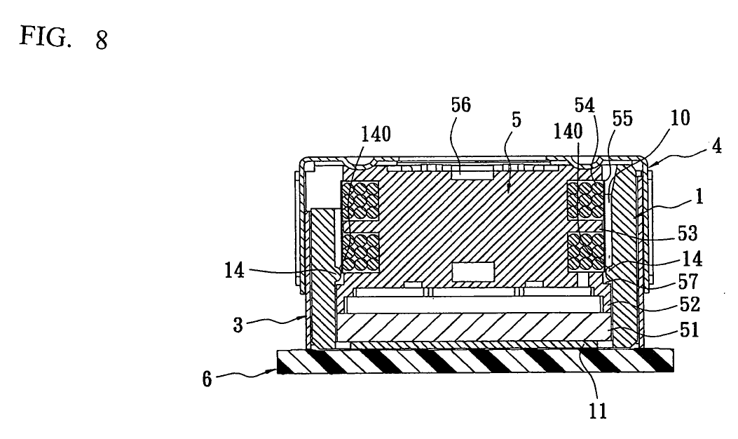

### DETAILED DESCRIPTION OF THE PREFERRED EMBODIMENTS

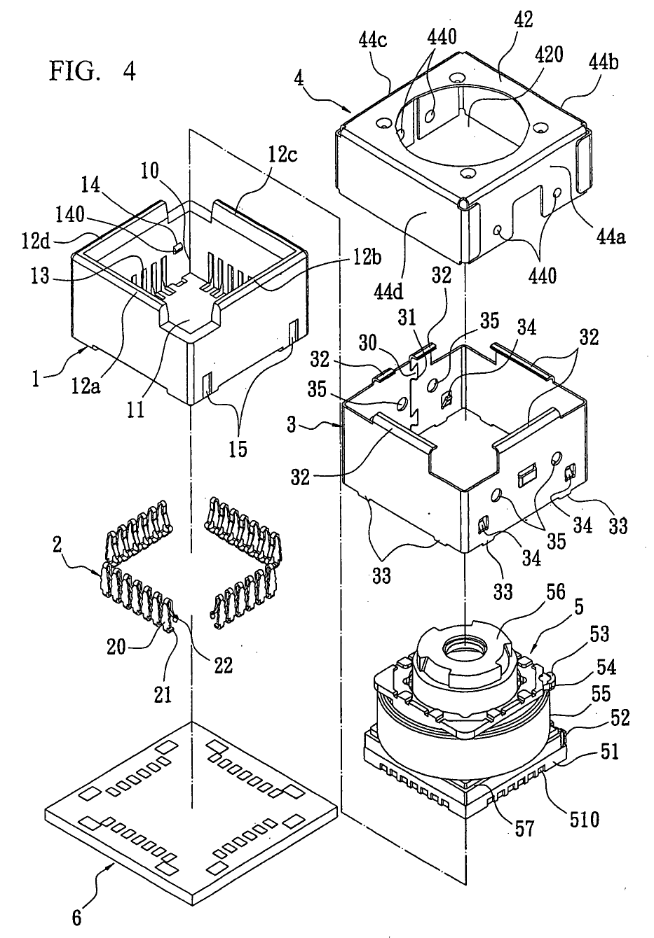

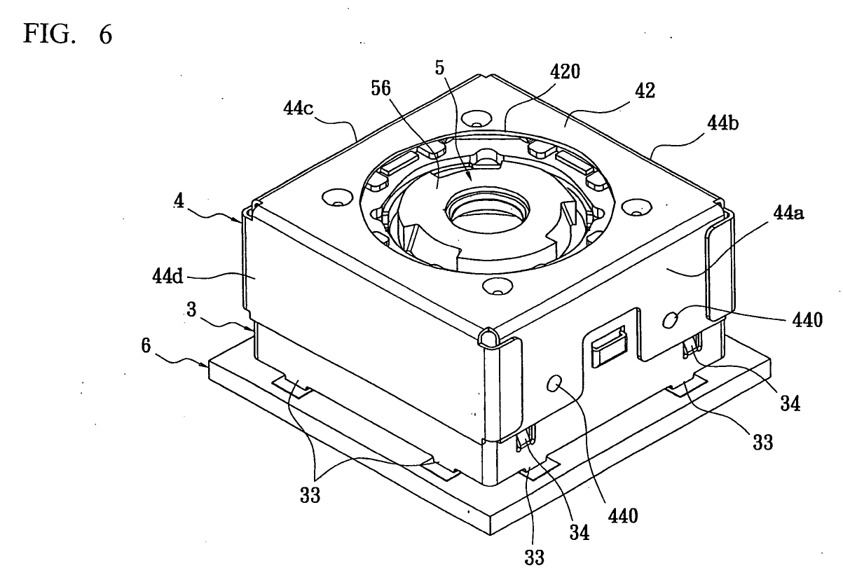

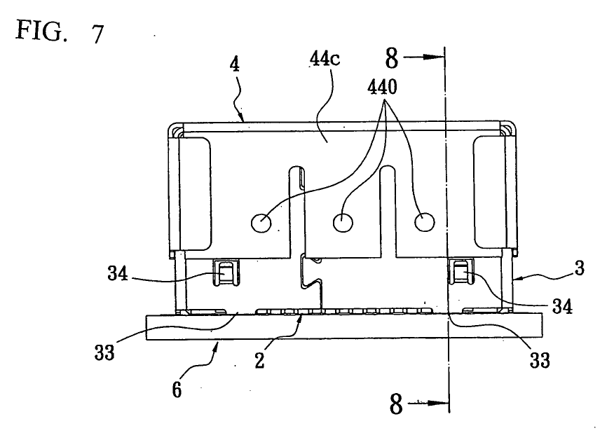

FIGS. 4 to 7 illustrate an electrical connector of the present invention. The present invention provides a camera module socket for mounting onto a circuit board 6 of an electronic product, such as a mobile phone. The connector includes an insulating casing or socket 1, a plurality of conductive terminals 2, a holding casing 3, a shielding casing 4 and a camera module 5.

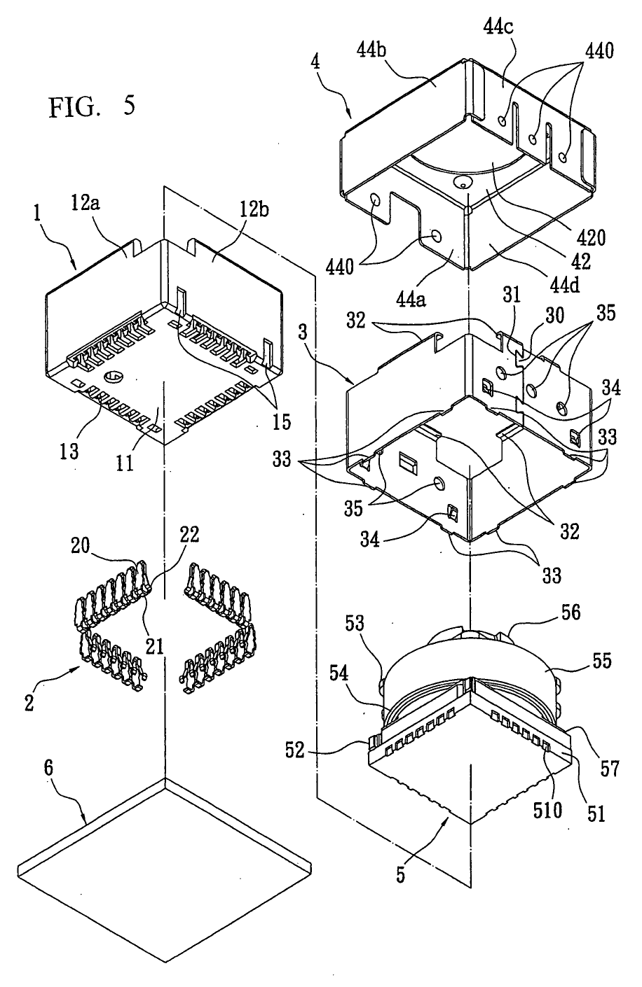

The camera module 5 is a variable-focus camera module that is constituted of a circuit board 51, a base 52, a coil support 53, a coil 54, an insulating tape 55 and a zoom lens 56. (FIG. 5) One side of the circuit board 51 is provided with electrical contacts 510 and the base 52 thereof is disposed on the circuit board 51. The coil support 53 is disposed on a top surface of the base 52, and the coil 54 is wrapped around the coil support 53. Insulating tape 55 covers the coil 54, and the lens 56 is disposed in the top portion of the coil support 53.

The socket 1 has a bottom wall 11 and four connected side walls 12a, 12b, 12c, 12d that define an accommodating space 10 collectively for accommodating the camera module 5. In order to accommodate the terminals 2, the inner surface of each of the side walls 12a, 12b, 12c, 12d of the socket 1 is provided with a plurality of terminal troughs or slots 13. Each terminal slot 13 penetrates through the bottom wall 11 of the socket 1.

In order to engage the camera module 5 in the socket 1, an engaging means is provided between the inner edge of the side walls 12a, 12b, 12c, 12d and the outer edge of the camera module 5. Via the engaging means, the camera module 5 can be engaged firmly in the accommodating space 10 of the socket 1.

Specifically, in the present embodiment, the engaging means includes a plurality of engaging pieces 14 and a stepped portion 57 corresponding to the engaging portions 14. The engaging pieces 14 are integrally formed on the inner edge of the side walls 12a, 12b, 12c, 12d of the socket 1. The stepped portion 57 is provided on the outer edge of the camera module 5. Each engaging piece 14 is a protruding block. The stepped portion 57 is a trough. The trough is formed between the outer edge of the bottom of the coil support 53 and the outer edge of the top of the base 52. Further, in the present embodiment, in order to facilitate the assembling process, the engaging pieces 14 formed on the inner edge of the side walls 12a, 12b, 12c, 12d of the socket 1 are characterized in that the outer surface of each of the engaging pieces is an inclined guiding surface 140 for allowing the camera module 5 to slide thereon smoothly. In this way, the camera module 5 can be assembled in the socket 1 easily.

The terminals 2 are accommodated in the corresponding terminal slots 13 respectively. Each of the terminals 2 has both ends. One end extends into the accommodating space 10 to be electrically connected with the camera module 5, while the other end extends beyond the socket 1 to be electrically connected with the circuit board 6 of the electronic product, thereby transferring the signal of the camera module 5 to the circuit board 6 of the electronic product. Each of the terminals 2 includes a fixing portion 20, a pin 21 and a contacting portion 22. The fixing portion 20 is fixed in the terminal slot 13 of the socket 1. The pin 21 extends downwardly from the fixing portion 20 to be electrically connected to the circuit board 6 of the electronic product. The contacting portion 22 extends from the fixing portion 20 toward the accommodating space 10 to be electrically connected with the electrical contacts 510 of a circuit board 51 of the camera module 5.

The holding casing 3 may be a square metallic frame. In the preferred embodiment of the present invention, the holding casing 3 is formed by means of bending a metallic plate and acts as a first shield. Both ends of the plate are provided with a dovetailed piece 30 and a dovetailed groove 31 that fit with each other. The holding casing 3 covers and is fixed to the outer periphery of the socket 1. The top end of the socket 3 is provided with clip or tab portions 32. The bottom end of the holding casing 3 is provided with soldering portions 33. The sides of the holding casing 3 are also provided with fixing portions 34. The tab portions 32 abut against the top of the side walls 12a, 12b, 12c, 12d of the socket 1, and the soldering portions 33 are soldered to the circuit board 6. The exterior of the side walls 12a, 12b, 12c, 12d of the socket 1 are provided with slots 15, and the fixing portions 34 are held in the slots 15.

The shielding casing or second shield 4 covers the outer periphery of the first shield casing 3 and the shielding casing 4 includes a square top plate 42 and four side plates 44a, 44b, 44c, 44d. Each side plate 44a, 44b, 44c, 44d extends downwardly from the edge of the top plate 42. The top plate 42 is provided with an open hole 420. The open hole 420 allows a lens 56 of the camera module 5 to be exposed to the outside. Two opposing side plates 44a, 44c of the shielding casing 4 are formed inwardly with a plurality of protrusions 440 respectively. The sides of the holding casing 3 are provided with a plurality of locking holes 35 corresponding to the protrusions 440. Via this arrangement, the shielding casing 4 can hold the camera module 5 in the electrical connector and also prevent an electromagnetic interference (EMI).

According to the above, the present invention provides an electrical connector, in which the engaging pieces provided on the inner edge of the socket are used to engage a desired variable-focus lens module, thereby changing the traditional way of holding the lens module by the holding arms on the sides of the metallic casing. Thus, during an assembling process, the problem that the holding arms may scrape off the insulating tape outside the variable-focus lens module to cause a short circuit is prevented.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electrical connector, comprising:
a lens module, an outer edge thereof being wrapped by coils;
an insulating casing having an accommodating space for accommodating the lens module, a bottom of the insulating casing being formed with a plurality of terminal troughs; and
a plurality of terminals accommodated in the terminal troughs respectively, each terminal having two ends, one end extending into the accommodating space to be electrically connected with the lens module, the other end extending beyond the insulating casing;
wherein an engaging means is provided between an inner edge of the insulating casing and an outer edge of the lens module, the lens module is engaged in the accommodating space of the insulating casing firmly via the engaging means.

2. The electrical connector according to claim 1, further comprising a holding casing covering and being fixed to an outer periphery of the insulating casing, a top end of the holding casing being provided with eaves portions, a bottom end of the holding casing being provided with soldering portions, the sides of the holding casing being provided with fixing portions, wherein the eaves portions abut against the top of the insulating portion, the soldering portions are soldered on a circuit board of an electronic product, the exterior of the sides of the insulating casing is provided with troughs, the fixing portions are held in the troughs.

3. The electrical connector according to claim 2, further comprising a shielding casing covering the outer periphery of the holding casing, the shielding casing comprising a square top plate and four side plates, each of the side plates extending downwardly from the edge of the top plate, the top plate being provided with an open hole for allowing the lens module to be exposed to the outside.

4. The electrical connector according to claim 3, wherein the side plates of the shielding casing and the sides of the holding casing are locked to each other via protrusions and locking holes.

5. The electrical connector according to claim 1, wherein the engaging means comprises a plurality of engaging pieces and a stepped portion corresponding to the engaging pieces, the engaging pieces are integrally formed on the inner edge of the insulating casing, the stepped portion is provided on the outer edge of the lens module.

6. The electrical connector according to claim 5, wherein each of the engaging pieces is a protruding block, and the stepped portion is a trough.

7. The electrical connector according to claim 6, wherein an outer surface of the protruding block is formed with an inclined guiding surface for allowing the lens module to slide thereon smoothly.

8. The electrical connector according to claim 1, wherein each of the terminals comprises a fixing portion fixed in the terminal trough of the insulating casing, a pin extending downwardly form the fixing portion, and a contacting portion extending from the fixing portion toward the accommodating space to be electrically connected with the lens module.
